(19) United States
(12) Patent Application Publication
(10) Pub. No.: US 2026/0045555 A1
(43) Pub. Date: Feb. 12, 2026

(54) ELECTROLYTE FOR FAST CHARGING OF LITHIUM SECONDARY BATTERY, LITHIUM SECONDARY BATTERY COMPRISING SAME, AND METHOD FOR MANUFACTURING LITHIUM SECONDARY BATTERY

(71) Applicant: THE INDUSTRY & ACADEMIC COOPERATION IN CHUNGNAM NATIONAL UNIVERSITY (IAC), Daejeon (KR)

(72) Inventors: Seung-Wan SONG, Sejong (KR); Kihun AN, Daejeon (KR); Seong Jun PARK, Daejeon (KR)

(21) Appl. No.: 19/101,404

(22) PCT Filed: Jul. 28, 2023
(86) PCT No.: PCT/KR2023/011037

§ 371 Date: Feb. 5, 2025

(30) Foreign Application Priority Data
Aug. 5, 2022 (KR) 10-2022-0097986

(51) Int. Cl. H01M 10/0569; H01M 4/02; H01M 4/525; H01M 10/0525; H01M 10/0567; H01M 10/0568; H01M 10/058; H01M 50/417; H01M 50/426; H01M 50/457

(52) U.S. Cl. CPC H01M 10/0569; H01M 4/525; H01M 10/0525; H01M 10/0567; H01M 10/0568; H01M 10/058; H01M 50/417; H01M 50/426; H01M 50/457; H01M 2004/028; H01M 2300/0034; H01M 2300/0037

(57) ABSTRACT

The present disclosure relates to an liquid electrolyte for fast charging of a lithium secondary battery, a lithium secondary battery including the same and a method for manufacturing a lithium secondary battery, and, by including an organic solvent including a linear carbonate-based solvent and a linear ester-based solvent, the liquid electrolyte is capable of improving fast charging properties and safety with no or little risk of thermal runaway, fire and explosion of a lithium secondary battery. In addition, battery properties such as capacity, a capacity retention and initial Coulombic efficiency of the lithium secondary battery, and battery lifetime are improved, fast charging of the battery is possible, and the battery lifetime may be improved even under a condition of high charging speed.

### TECHNICAL FIELD

The present disclosure relates to an liquid electrolyte for a fast-charging lithium secondary battery, a lithium secondary battery including the same and a method for manufacturing a lithium secondary battery.

### BACKGROUND ART

A lithium secondary battery is formed with a positive electrode, a negative electrode, a separator and an liquid electrolyte. As the liquid electrolyte, a non-aqueous organic liquid electrolyte having lithium ion conductivity is used, which causes a problem of being vulnerable to fire and explosion due to its flammable nature. This poses a great threat to safety of users and surrounding environments in the event of accidents such as thermal runaway, fire and explosion of a lithium secondary battery.

Particularly, a medium to large lithium secondary battery used in electric vehicles (EV), aviation, energy storage systems (ESS) and the like has an amplified risk of thermal runaway, fire and explosion, and various studies to overcome such a risk are in progress.

As an example, a method of using an additive having flame retardancy such as phosphazene, phosphate, phosphite, an ionic liquid or an aqueous liquid electrolyte has been proposed, however, there are problems of an increase in cost caused by a high price, and degradation of battery performance or a decrease in energy density.

Studies on a solid electrolyte-based all-solid-state battery are also in progress, however, there is a problem of large interfacial resistance between a solid electrolyte and an electrode, which leads to problems in that long-term charge-discharge performance is impossible and it is difficult to improv energy density, and in addition thereto, there is a problem in that electrode, electrolyte and all-solid-state battery manufacturing processes and operations require ultra-high voltage, making the battery more expensive compared to existing batteries. In addition, an all-solid-state battery has a problem in that fast charging is difficult due to low ion conductivity and high interfacial resistance of a solid electrolyte and risk of dendrite formation.

In other words, although safety is improved in all of these, there are problems in that battery performance is degraded, battery price increases, and fast charging is difficult. Accordingly, development of an liquid electrolyte capable of preventing battery performance from being degraded and improving charging speed while improving safety of a lithium secondary battery is still required.

In addition, in order to continuously expand the market for a lithium secondary battery, fast charging properties need to be secured as well as securing high energy density, long lifetime and safety.

Accordingly, studies for developing fast charging performance of a lithium secondary battery have been conducted globally, however, most of the studies focus on the development of electrode materials, and there are almost no studies in terms of an liquid electrolyte.

### PRIOR ART DOCUMENTS

### Patent Documents

(Patent Document 1) 10-2016-0011548 A1

### DISCLOSURE

### Technical Problem

The present disclosure is directed to providing an liquid electrolyte for a fast-charging lithium secondary battery, a lithium secondary battery including the same and a method for manufacturing a lithium secondary battery.

The present disclosure is also directed to providing an liquid electrolyte capable of improving fast charging properties and safety with no or little risk of fire and explosion of a lithium secondary battery by including an organic solvent including a linear carbonate-based solvent and a linear ester-based solvent.

The present disclosure is also directed to providing a lithium secondary battery having improved battery properties of a lithium secondary battery such as capacity, capacity retention rate and initial Coulombic efficiency and improved battery lifetime, capable of fast charging of a battery, and having an improved battery lifetime even under a condition of high charging speed, and a method for manufacturing the same.

### Technical Solution

In view of the above, one embodiment of the present disclosure relates to an liquid electrolyte for fast charging of a lithium secondary battery, the liquid electrolyte including: a lithium salt; a first solvent including a compound represented by the following Chemical Formula 1; and a second solvent including a compound represented by the following Chemical Formula 2:

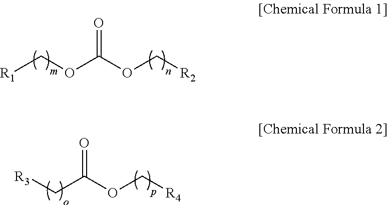

wherein,
n, m, o and p are the same as or different from each other, and each independently an integer of 0 to 5, and
R₁ to R₄ are the same as or different from each other, and may be each independently selected from the group consisting of hydrogen, a substituted or unsubstituted alkyl group having 1 to 10 carbon atoms, a substituted or unsubstituted alkenyl group having 2 to 10 carbon atoms and a substituted or unsubstituted alkynyl group having 2 to 10 carbon atoms.

The lithium salt may be selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆HsSO₃, LiN(C₂FsSO₃)₂, LiN(C₂F₅SO₂)₂, LiN(CF₃SO₂)₂. LiN(FSO₂)₂, LiN(CₓF₂ₓ₊₁SO₂)(C_{y}F_{2y+1}SO₂) (herein, x and y are 0 or natural number), LiCl, LiI, LiSCN, LiB(C₂O₄)₂, LiF₂BC₂O₄, LiPF₄(C₂O₄), LiPF₂(C₂O₄)₂, LiPO₂F₂, LiP(C₂O₄)₃ and mixtures thereof.

The first solvent and the second solvent may be included in a volume ratio of 99:1 to 1:99.

The lithium salt may be included in a concentration of 0.1 M to 60 M.

The liquid electrolyte composition may further include an additive selected from the group consisting of vinylene carbonate (VC), vinylene ethylene carbonate (VEC), propane sultone (PS), fluoroethylene carbonate (FEC), ethylene sulfate (ES), pentaerythritol disulfate (PDS), lithium fluorophosphate (LiPO₂F₂), lithium oxalyl difluoroborate (LiODFB), hexafluoro glutaric anhydride (HFA), lithium bis(oxalato)borate (LiBOB) and mixtures thereof, however, the additive is not limited thereto.

The additive may be included in an amount of 0.1% by weight to 13% by weight in a total weight of the liquid electrolyte.

A lithium secondary battery according to another embodiment of the present disclosure may include a positive electrode including a positive electrode active material; the liquid electrolyte for fast charging; a negative electrode; and a separator.

The positive electrode may include a nickel-rich NCM-based material as the positive electrode active material.

The separator may be polyethylene, polypropylene, polyvinylidene fluoride or a multilayer film of two or more layers thereof, or ceramic coated.

A method for manufacturing a lithium secondary battery according to another embodiment of the present disclosure may include a) preparing a positive electrode including a positive electrode active material, a polymer binder and a conductor on a current collector; b) preparing an electrode assembly in which the positive electrode, a separator and a negative electrode are sequentially interposed; and c) inserting the electrode assembly into a battery case, and injecting a lithium salt and the liquid electrolyte for fast charging thereinto.

The lithium secondary battery may be a lithium ion secondary battery, a lithium metal secondary battery or an all-solid-state lithium secondary battery.

In the present disclosure, “hydrogen” is hydrogen, light hydrogen, deuterium or tritium.

In the present disclosure, a “halogen group” is fluorine, chlorine, bromine or iodine.

In the present disclosure, an “alkyl” means a monovalent substituent derived from a linear or branched saturated hydrocarbon having 1 to 40 carbon atoms. Examples thereof may include methyl, ethyl, propyl, isobutyl, sec-butyl, pentyl, iso-amyl, hexyl and the like, but are not limited thereto.

In the present specification, “substituted” means that a hydrogen atom bonding to a carbon atom of a compound is changed to another substituent, and the position of substitution is not limited as long as it is a position at which the hydrogen atom is substituted, that is, a position at which the substituent is capable of substituting, and when two or more substituents substitute, the two or more substituents may be the same as or different from each other. The substituent may be substituted with one or more substituents selected from the group consisting of hydrogen, a cyano group, a nitro group, a halogen group, a hydroxyl group, a carboxyl group, an alkoxy group having 1 to 10 carbon atoms, an alkyl group having 1 to 30 carbon atoms, an alkenyl group having 2 to 30 carbon atoms, an alkynyl group having 2 to 24 carbon atoms, a heteroalkyl group having 2 to 30 carbon atoms, an aralkyl group having 6 to 30 carbon atoms, an aryl group having 5 to 30 carbon atoms, a heteroaryl group having 2 to 30 carbon atoms, a heteroarylalkyl group having 3 to 30 carbon atoms, an alkoxy group having 1 to 30 carbon atoms, an alkylamino group having 1 to 30 carbon atoms, an arylamino group having 6 to 30 carbon atoms, an aralkylamino group having 6 to 30 carbon atoms and a heteroarylamino group having 2 to 24 carbon atoms, and when substituted with a plurality of substituents, these are the same as or different from each other, and the substituent is not limited to the above-described examples.

### Advantageous Effects

The present disclosure relates to an liquid electrolyte capable of improving fast charging properties and safety with no or little risk of thermal runaway, fire and explosion of a lithium secondary battery by including an organic solvent including a linear carbonate-based solvent and a linear ester-based solvent.

In addition, the present disclosure relates to a lithium secondary battery having improved battery properties such as capacity, capacity retention rate and initial Coulombic efficiency and improved battery lifetime, capable of fast charging of a battery, and having an improved battery lifetime even under a condition of high charging speed, and a method for manufacturing the same.

### BRIEF DESCRIPTION OF DRAWINGS

FIG. 1 shows a result of measuring discharge capacity of a SiO-graphite//NCM811 coin cell including an liquid electrolyte for fast charging according to one embodiment of the present disclosure.

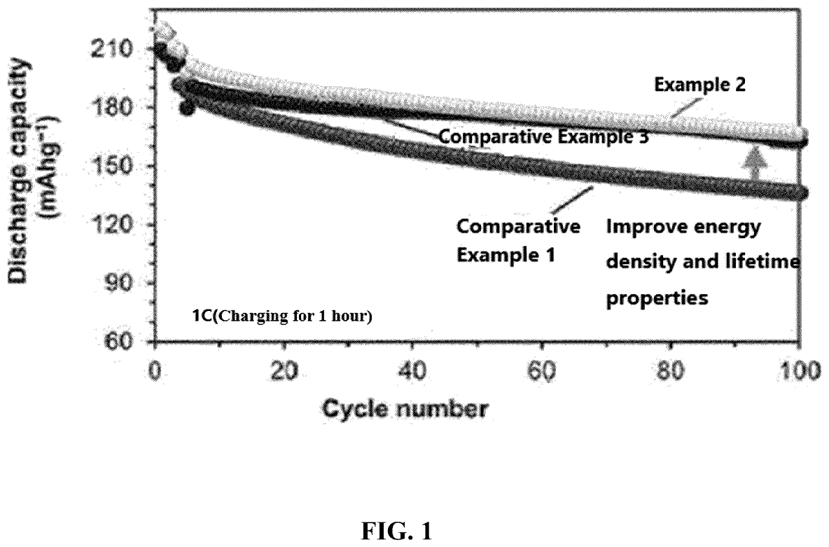

FIG. 2 shows a result of measuring discharge capacity of a graphite//NCM811 pouch cell including an liquid electrolyte for fast charging according to one embodiment of the present disclosure.

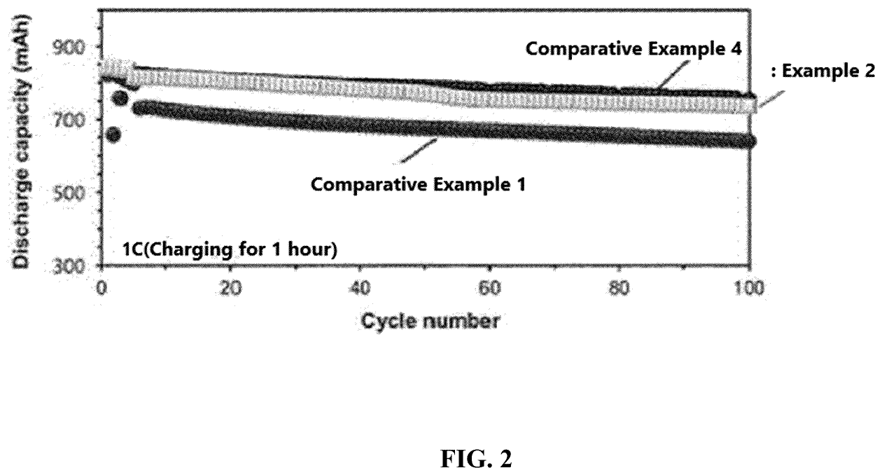

FIG. 3 shows a result of measuring discharge capacity of a graphite//NCM811 pouch cell including an liquid electrolyte for fast charging according to one embodiment of the present disclosure.

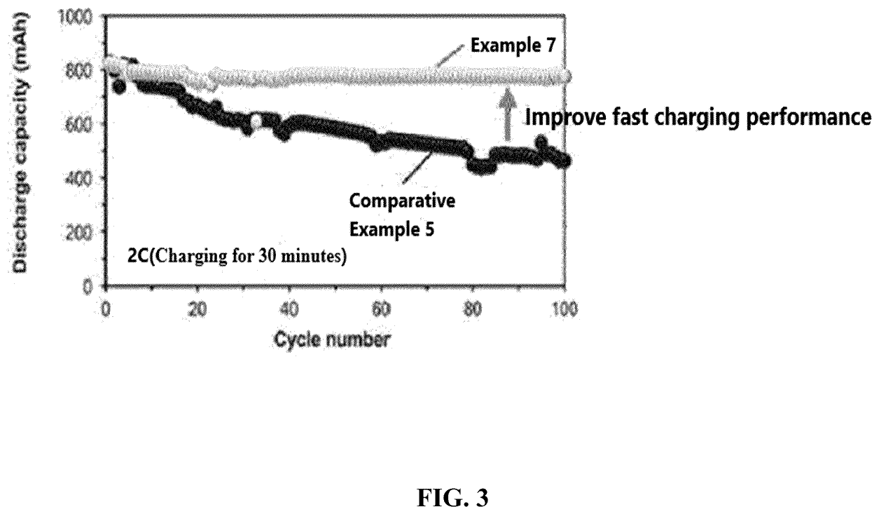

FIG. 4 shows a result of measuring discharge capacity of a graphite//NCM811 pouch cell including an liquid electrolyte for fast charging according to one embodiment of the present disclosure.

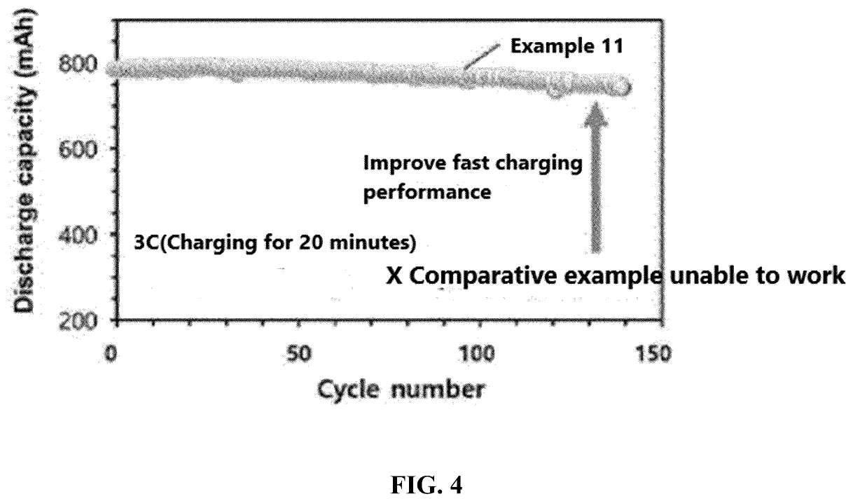

### BEST MODE

The present disclosure relates to an liquid electrolyte for fast charging of a lithium secondary battery, the liquid electrolyte including: a lithium salt; a first solvent including a compound represented by the following Chemical Formula 1; and a second solvent including a compound represented by the following Chemical Formula 2,

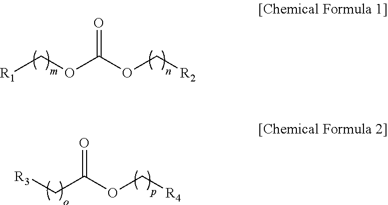

herein, n, m, o and p are the same as or different from each other and each independently an integer of independently 0 to 5, and R₁ to R₄ are the same as or different from each other and may be each independently selected from the group consisting of hydrogen, a substituted or unsubstituted alkyl group having 1 to 10 carbon atoms, a substituted or unsubstituted alkenyl group having 2 to 10 carbon atoms and a substituted or unsubstituted alkynyl group having 2 to 10 carbon atoms.

Hereinafter, a lithium secondary battery according to the present disclosure, and a method for manufacturing the same will be described in detail. Drawings introduced below are provided as an example so that the spirit of the present disclosure is sufficiently conveyed to those skilled in the art. Accordingly, the present disclosure may be embodied in other forms without being limited to the drawings provided below, and the drawings provided below may be exaggerated to clarify the spirit of the present disclosure. Technical terms and scientific terms used herein have meanings commonly understood by those having ordinary knowledge in the art unless defined otherwise, and descriptions on known functions and constitutions that may unnecessarily obscure the gist of the present disclosure will not be provided in the following descriptions and accompanying drawings.

A lithium secondary battery is charged and stores energy as lithium ions stored in a positive electrode migrate to a negative electrode through an electrolyte, and is discharged and generates energy as the lithium ions stored in the negative electrode migrate to the positive electrode.

The charging time may be reduced as the lithium ions migrate faster to the negative electrode and are stored during charging. However, when existing lithium secondary batteries undergo fast charging, it is likely that lithium is precipitated on the negative electrode surface made of graphite and grow into needle-shaped dendrites. When lithium dendrites grow as described above, the dendrites pierce a separator to be brought into contact with the positive electrode, causing a problem of ignition after going through thermal runaway as an internal short circuit occurs.

Even in cases other than the above-described fast-charging cases, commercially available liquid electrolytes of a lithium secondary battery are vulnerable to fire and explosion by having flammable properties, posing a great threat to safety of users and surrounding environments.

In order to overcome such a problem, a method of using an additive having flame retardancy such as phosphazene, phosphate, phosphite or an ionic liquid, and an all-solid-state battery based on solid electrolytes such as polymers, sulfides and oxides have been proposed. However, these all have problems of degrading battery performance and increasing battery price despite improved safety.

Accordingly, the present disclosure relates to an liquid electrolyte for fast charging of a lithium secondary battery, and relates to an liquid electrolyte for a lithium secondary battery capable of preventing degradation of battery performance while improving safety.

The liquid electrolyte is an liquid electrolyte having excellent stability with no or little risk of fire and explosion as well as capable of fast charging when using a mixture of two different series of solvents and using nickel-rich NCM (nickel-cobalt-manganese) as a positive electrode active material, and a lithium secondary battery including the liquid electrolyte of the present disclosure is capable of providing excellent stability, fast charging, high performance, long lifetime and high energy density.

Specifically, the liquid electrolyte for fast charging of a lithium secondary battery according to one embodiment of the present disclosure may include a lithium salt; a first solvent including a compound represented by the following Chemical Formula 1; and a second solvent including a compound represented by the following Chemical Formula 2:

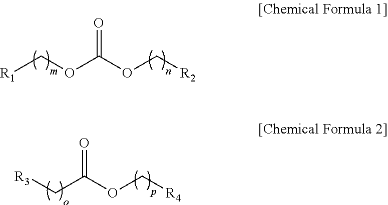

herein,
n, m, o and p are the same as or different from each other, and each independently an integer of 0 to 5, and
R₁ to R₄ are the same as or different from each other, and may be each independently selected from the group consisting of hydrogen, a substituted or unsubstituted alkyl group having 1 to 10 carbon atoms, a substituted or unsubstituted alkenyl group having 2 to 10 carbon atoms and a substituted or unsubstituted alkynyl group having 2 to 10 carbon atoms.

By using a mixed solvent of the first solvent including the compound represented by Chemical Formula 1 and the second solvent including the compound represented by Chemical Formula 2 in the liquid electrolyte, a non-aqueous liquid electrolyte is provided, and when using the non-aqueous liquid electrolyte in a lithium secondary battery, a lithium secondary battery capable of being fast-charged three times or more faster than a battery that uses existing liquid electrolytes, and having excellent battery performance may be provided.

In addition, the liquid electrolyte including the first solvent and the second solvent may have a non-ignition property of flame retardancy or non-flammability, and through this, accidents such as a lithium secondary battery catching fire or exploding may be prevented from occurring in the event of a disaster such as fire, and safety may be greatly improved.

More specifically, the first solvent may include a linear carbonate-based compound represented by the following Chemical Formula 1:

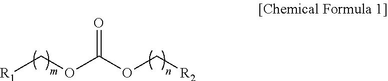

herein,
n and m are the same as or different from each other, and each independently an integer of 0 to 5, and
R₁ and R₂ are the same as or different from each other, and may be each independently selected from the group consisting of hydrogen, a substituted or unsubstituted alkyl group having 1 to 10 carbon atoms, a substituted or unsubstituted alkenyl group having 2 to 10 carbon atoms and a substituted or unsubstituted alkynyl group having 2 to 10 carbon atoms.

As a specific example, the compound represented by the following Chemical Formula 1 may be selected from the group consisting of ethylmethyl carbonate (EMC), dimethyl carbonate (DMC), diethyl carbonate (DEC), 2,2,2-trifluoroethylmethyl carbonate (FEMC), di-2,2,2-trifluoroethyl carbonate (DFDEC) and mixtures thereof, however, linear carbonate-based compounds enabling fast charging of a lithium secondary battery may all be used without limit.

The second solvent may include a linear ester-based compound represented by the following Chemical Formula 2:

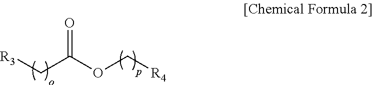

herein,
n and m are the same as or different from each other, and each independently an integer of 0 to 5, and
R₁ and R₂ are the same as or different from each other, and may be each independently hydrogen or a substituted or unsubstituted alkyl group having 1 to 10 carbon atoms.

As a specific example, the compound represented by Chemical Formula 2 may be selected from the group consisting of fluoromethyl acetate, difluoromethyl acetate, trifluoromethyl acetate, 2-fluoroethyl acetate, 2,2-difluoroethyl acetate, 2,2,2-trifluoroethyl acetate, fluoromethyl propionate, difluoromethyl propionate, trifluoromethyl propionate, 2-fluoroethyl propionate, 2,2-difluoroethyl propionate, 2,2,2-trifluoroethyl propionate, 2-fluoroethyl butyrate, 2,2-difluoroethyl butyrate, 2,2,2-trifluoroethyl butyrate (TFEB) and mixtures thereof, but is not limited to the examples of the compound, and linear ester-based compounds enabling fast charging of a lithium secondary battery may all be used without limit.

In addition, by using the mixed solvent of the first solvent including the compound represented by Chemical Formula 1 and the second solvent including the compound represented by Chemical Formula 2 in the liquid electrolyte, the non-aqueous liquid electrolyte may have a non-ignition property of flame retardancy or non-flammability, and through this, accidents such as a lithium secondary battery catching fire or exploding may be prevented from occurring in the event of a disaster such as fire, and safety may be greatly improved.

Specifically, the ignition property of an liquid electrolyte may be defined such that, depending on a self-extinguishing time (SET (unit: second/g)), SET<6 is defined as non-flammable, 6<SET<20 as flame retardant and SET>20 as flammable, and the flame retardant or non-flammable liquid electrolyte according to one embodiment of the present disclosure may have a self-extinguishing time of less than 20 seconds/g, more preferably less than 6 second/g, and even more preferably less than 3 seconds/g. Herein, the self-extinguishing time may have a lower limit of 0 second/g. Through the self-extinguishing time property as above, the liquid electrolyte of the present disclosure may exhibit an ignition property of flame retardancy or non-flammability.

In addition, unlike existing methods in which battery performance is degraded when safety is improved, battery performance may be prevented from being degraded while securing a non-ignition property through combining the liquid electrolyte including a mixed solvent of the first solvent and the second solvent, and, as to be described below, a nickel-rich NCM positive electrode active material represented by Chemical Formula 3.

The first solvent and the second solvent may have a volume ratio of 99:1 to 1:99, 90:10 to 10:90, 90:10 to 20:80, 90:10 to 30:70, or 80:20 to 40:60. By mixing the solvents in such a volume ratio, an liquid electrolyte capable of fast charging may be provided, a non-ignition property of less than 20 seconds/g may be secured at the same time, and, when using nickel-rich NCM as a positive electrode active material, a lithium secondary battery having discharge capacity of 190 mAh/g or greater after 100 charge-discharge cycles, a capacity retention rate of 70% or greater after 100 charge-discharge cycles and initial Coulombic efficiency of 80% or greater may be provided. Herein, an upper limit of the discharge capacity is not particularly limited as it changes depending on the charging speed, however, the upper limit may be, for example, 250 mAh/g.

In addition, when using nickel-rich NCM as a positive electrode active material under a 2 C (charge in 30 minutes) condition, a lithium secondary battery having discharge capacity of 180 mAh/g or greater after 100 charge-discharge cycles, a capacity retention rate of 80% or greater after 100 charge-discharge cycles and initial Coulombic efficiency of 95% or greater may be provided.

In addition, when using nickel-rich NCM as a positive electrode active material under a 3 C (charge in 20 minutes) condition, a lithium secondary battery having discharge capacity of 160 mAh/g or greater after 100 charge-discharge cycles, a capacity retention rate of 70% or greater after 100 charge-discharge cycles and initial Coulombic efficiency of 95% or greater may be provided.

Furthermore, the flame retardant or non-flammable liquid electrolyte includes a lithium salt, and the lithium salt may be selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂, LiN(FSO₂)₂, LiN(CₓF₂ₓ₊₁SO₂)(C_{y}F_{2y+1}SO₂) (herein, x and y are 0 or natural number), LiCl, LiI, LiSCN, LiB(C₂O₄)₂, LiF₂BC₂O₄, LiPF₄(C₂O₄), LiPF₂(C₂O₄)₂, LiPO₂F₂, LiP(C₂O₄)₃ and mixtures thereof. However, those commonly used in the art may be used without particular limit.

The lithium salt in the flame retardant or non-flammable liquid electrolyte may have a concentration of 0.1 M to 60 M, more preferably 0.5 M to 10 M, and even more preferably 0.9 M to 1.5 M. However, the concentration is not limited to the above-mentioned range, and lithium salt concentration ranges enabling the electrolyte to exhibit flame retardancy or non-flammability and excellent stability may all be used.

The flame retardant or non-flammable liquid electrolyte may further include an additive, and as the additive, those commonly used in the art may be used without particular limit. The liquid electrolyte composition may further include an additive selected from the group consisting of vinylene carbonate (VC), vinylene ethylene carbonate (VEC), propane sultone (PS), fluoroethylene carbonate (FEC), ethylene sulfate (ES), pentaerythritol disulfate (PDS), lithium fluorophosphate (LiPO₂F₂), lithium oxalyl difluoroborate (LiODFB), hexafluoro glutaric anhydride (HFA), lithium bis(oxalato)borate (LiBOB) and mixtures thereof, and preferably, may further include an additive selected from the group consisting of vinylene carbonate (VC), fluoroethylene carbonate (FEC), hexafluoro glutaric anhydride (HFA) and mixtures thereof. However, the additive is not limited to the above-mentioned examples.

The added amount of the additive in the liquid electrolyte may also be adjusted to a level commonly used in the art, and specifically, the added amount of the additive may be, for example, 0.1% by weight to 13% by weight, 0.2% by weight to 5% by weight or 0.1% by weight to 2% by weight in the total weight of the liquid electrolyte. By including the additive in the above-mentioned range, battery performance may be improved through fast charging.

A lithium secondary battery according to another embodiment of the present disclosure may include a positive electrode including a positive electrode active material; the liquid electrolyte for fast charging; a negative electrode; and a separator.

As the positive electrode active material, a compound represented by the following Chemical Formula 3, LiMn₂₋cM_{c}O₄, LiFePO₄, LiMnPO₄, LiCoPO₄, LiFe_{1-c}McPO₄, Li_{1.2}Mn_{(0.8-d)}MdO₂, Li₂N_{1-c}McO₃ (N and M are metal or transition metal), Li_{1.2-f}A_{f}Mn_{(0.8-d-e)}M_{d}NₑO₂ (A is alkali metal, N and M are metal or transition metal), Li₁₊ₑN_{y-c}McO₂ (N is Ti or Nb, M is V, Ti, Mo or W), Li₄Mn_{2-c}M_{c}O₅(M is metal or transition metal), Li_{c}M_{2-c}O₂, Li₂O/Li₂Ru_{1-c}M_{c}O₃, active materials of which surfaces are coated with oxides, fluorides and the like, may be used, however, these are just an example, and known positive electrode active materials may be used without limit:

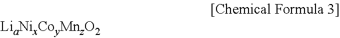

herein,

$$0.8 \leq a \leq 1.2 ,$$

$$0.3 < x \leq 1 ,$$

$$0 \leq y < 0.5 ,$$

$$0 \leq z < 0.6 , and$$

$$x + y + z = 1.$$

M and N of the compound expressed as the positive electrode active material mean a metal or transition metal. The metal or transition metal may be Al, Mg, B, Co, Fe, Cr, Ni, Ti, Nb, V, Mo or W, however, all may be used without being limited to the above-mentioned scope. In addition, c may be 0, 0.2, 0.5 or the like, but is not limited to the above-mentioned examples, and compounds usable as a positive electrode active material may all be used.

The compound represented by Chemical Formula 3 may be a compound represented by the following Chemical Formula 4:

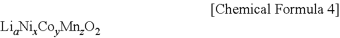

herein,

$$0.9 \leq a \leq 1.1 ,$$

$$0.6 \leq x \leq 0.95 ,$$

$$n 0 \leq y \leq 0.2 ,$$

$$0.01 \leq z \leq 0.3 , and$$

$$x + y + z = 1.$$

In addition, in Chemical Formula 4, a, x, y and z may be preferably 0.95≤a≤1.05, 0.7≤x≤0.9, 0≤y≤0.15, 0.05≤z≤0.15, and x+y+z=1.

As described above, by using the nickel-rich NCM-based material represented by Chemical Formula 3 as the positive electrode active material, battery performance may be prevented from being degraded despite the use of the flame retardant or non-flammable liquid electrolyte.

Specifically, by using the nickel-rich NCM-based material represented by Chemical Formula 3 as the positive electrode active material, fast charging is possible, and high performance and high energy density may be accommodated, while having excellent safety with no or little risk of fire and explosion.

As the negative electrode, those commonly used in the art may be used without particular limit. As a specific example, lithium metal, a lithium alloy, or a negative electrode active material capable of intercalating/deintercalating lithium ions may be used as the negative electrode. The negative electrode active material may be selected from the group consisting of cokes, artificial graphite, natural graphite, soft carbon, hard carbon, an organic polymer compound combustor, carbon fiber, carbon nanotube, graphene, silicon, silicon oxide, tin, tin oxide, germanium, or a graphite composite including silicon, silicon oxide, tin, tin oxide or germanium, Li₄Ti₅O₁₂, TiO₂, phosphorus and mixtures thereof, but is not limited to the above-mentioned scope, and negative electrode active materials known in the art may all be used without limit.

As the separator, polyethylene, polypropylene, polyvinylidene fluoride or a multilayer film of two or more layers thereof may be used, and a mixed multilayer film such as a polyethylene/polypropylene two-layer separator, a polyethylene/polypropylene/polyethylene three-layer separator or a polypropylene/polyethylene/polypropylene three-layer separator, a separator in which a single surface or both surfaces of these separators are ceramic coated, and the like may be used. However, these are just an example, and separators known in the art may all be used without limit.

Meanwhile, the lithium secondary battery may be a lithium ion secondary battery, a lithium metal secondary battery, an all-solid-state lithium secondary battery or the like, and may be used in portable electronic devices such as smartphones, wearable electronic devices, power tools, drones, electric vehicles (EV), electric trucks, energy storage systems (ESS), electric two-wheeled vehicles including electric bicycles, electric scooters and the like, electric golf carts, electric wheelchairs, aviation, electric planes, electric boats, electric submarines and the like.

In addition, the lithium secondary battery of the present disclosure may be manufactured in various shapes and sizes such as, in addition to a coin-type, a prismatic-type, a cylindrical-type or a pouch-type.

In addition, as another embodiment of the present disclosure, a method for manufacturing a lithium secondary battery may include a) preparing a positive electrode including a positive electrode active material represented by the following Chemical Formula 3, a polymer binder and a conductor on a current collector; b) preparing an electrode assembly in which the positive electrode, a separator and a negative electrode are sequentially interposed; and c) inserting the electrode assembly into a battery case, and injecting a lithium salt and the liquid electrolyte for fast charging to manufacture a lithium secondary battery:

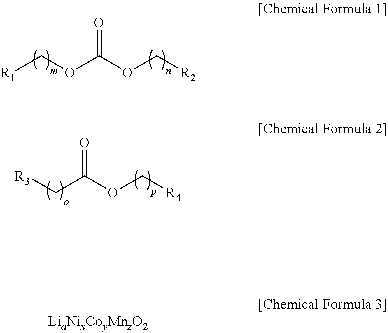

herein,
n, m, o and p are the same as or different from each other, and each independently an integer of 0 to 5,
R₁ to R₄ are the same as or different from each other, and each independently hydrogen or a substituted or unsubstituted alkyl group having 1 to 10 carbon atoms,

$$0.8 \leq a \leq 1.2 ,$$

$$0.3 < x \leq 1 ,$$

$$0 \leq y < 0.5 ,$$

$$0 \leq z < 0.6 , and$$

$$x + y + z = 1.$$

First, a) preparing a positive electrode by coating a positive electrode slurry, in which the positive electrode active material represented by Chemical Formula 3, a polymer binder and a conductor are mixed, on a current collector may be performed.

Herein, the type of the positive electrode active material is the same as described above, therefore, repeated description will not be provided, and although the added amount of the positive electrode active material is not particularly limited in the content range, the positive electrode active material may be specifically included in an amount of 40% by weight to 99% by weight, more preferably 50% by weight to 98% by weight, and even more preferably 65% by weight to 96% by weight with respect to the total weight of the positive electrode slurry. However, this is just a non-limiting example, and the content is not limited to the above-mentioned numerical range.

The polymer binder according to another embodiment of the present disclosure performs a role of improving adhesive strength between the positive electrode active material particles or between the positive electrode active material and the current collector. Specific examples thereof may include polyvinylidene fluoride (PVDF), polyimide (PI), fluoropolyimide (FPI), polyacrylic acid (PAA), polyvinyl alcohol (PVA), carboxymethyl cellulose (CMC), starch, hydroxypropyl cellulose, regenerated cellulose, polyvinyl pyrrolidone (PVP), tetrafluoroethylene, polyethylene, polypropylene, an ethylene-propylene-diene polymer (EPDM), a sulfonated-EPDM, styrene-butadiene rubber (SBR), polytetrafluoroethylene (PTFE), fluororubber, various copolymers thereof or the like. These may be used either alone as one type or as a mixture of two or more types, however, this is just an example, and binders known in the art may be used without limit.

The polymer binder is not particularly limited in the content range, but may be specifically included in an amount of 1% by weight to 50% by weight, more preferably 2% by weight to 20% by weight, and even more preferably 3% by weight to 15% by weight with respect to the total weight of the positive electrode slurry. However, this is just a non-limiting example, and the content is not limited to the above-mentioned numerical range.

The conductor according to another embodiment of the present disclosure is used to provide conductivity to the electrodes, and those having electronic conductivity without causing chemical changes may be used without particular limit. Specific examples thereof may include graphite; carbon-based materials such as carbon black, acetylene black, ketjen black, channel black, furnace black, lamp black, thermal black, carbon fiber, carbon nanotube, carbon nanowire and graphene; metal powders or metal fibers of copper, nickel, aluminum, silver and the like; conductive whiskers such as zinc oxide and potassium titanate; conductive metal oxides such as titanium oxide; or conductive polymers such as polyphenylene derivatives, and the like. These may be used either alone as one type or as a mixture of two or more types, however, this is just an example, and conductors known in the art may be used without limit.

The conductor is not particularly limited in the content range, but may be specifically included in an amount of 0% by weight to 50% by weight, more preferably 1% by weight to 30% by weight, and even more preferably 3% by weight to 20% by weight with respect to the total weight of the positive electrode slurry. However, this is just a non-limiting example, and the content is not limited to the above-mentioned numerical range.

In addition, the positive electrode slurry may further include a solvent for mixing and dispersing the polymer binder, the positive electrode active material and the conductor. Examples of the solvent may include any one selected from among amine-based solvents such as N,N-dimethylaminopropylamine, diethylenetriamine and N,N-dimethylformamide (DMF); ether-based solvents such as tetrahydrofuran; ketone-based solvents such as methyl ethyl ketone; ester-based solvents such as methyl acetate; amide-based solvents such as dimethylacetamide and 1-methyl-2-pyrrolidone (NMP); dimethyl sulfoxide (DMSO) and the like, or a mixed solvent of two or more thereof, however, the solvent is not limited thereto.

The positive electrode according to another embodiment of the present disclosure may have a coating thickness of 10 μm to 300 μm, more preferably 10 μm to 100 μm, and even more preferably 10 μm to 50 μm, however, the thickness is not limited thereto. When the positive electrode slurry is coated to the coating thickness as above, resistance decreases when transferring lithium ions, and battery performance may be further improved.

Meanwhile, the current collector according to another embodiment of the present disclosure may be used without particular limit as long as it is a material having electrical conductivity and capable of applying an electric current to the positive electrode material. For example, any one or more selected from the group consisting of C, Ti, Cr, Mo, Ru, Rh, Ta, W, Os, Ir, Pt, Au and Al may be used. Specifically, C, Al, stainless steel or the like may be used as the current collector, and more specifically, Al is preferred in terms of cost and efficiency. A current collector in which a carbon layer is coated on a surface of the current collector may be used. The shape of the current collector is not particularly limited, however, a thin film substrate, a three-dimensional substrate such as foamed metal, mesh, woven fabric, non-woven fabric or foam, or the like may be used, and this is effective in terms of high rate and charge-discharge properties since the positive electrode slurry sufficiently adheres to the current collector, resulting in an electrode with high capacity density even when the content of the polymer binder is low.

Next, b) preparing an electrode assembly in which the positive electrode, a separator and a negative electrode are sequentially interposed may be performed, and this step may be performed according to a common method.

Then, c) inserting the electrode assembly into a battery case, and injecting a lithium salt and the liquid electrolyte for fast charging according to one embodiment of the present disclosure to manufacture a lithium secondary battery may be performed.

Herein, the liquid electrolyte for fast charging is the same as described above, therefore, repeated description will not be provided, and the method of injecting the liquid electrolyte may be performed according to a common method.

Hereinafter, the lithium secondary battery and the method for manufacturing the same according to the present disclosure will be described in more detail with reference to examples. However, the following examples are just a reference to describe the present disclosure in detail, and the present disclosure is not limited thereto and may be embodied in various forms.

In addition, unless defined otherwise, all technical terms and scientific terms have the same meanings as meanings generally understood by one of those skilled in the art. Terms used in the description herein are only for effectively describing specific examples, and are not intended to limit the present disclosure. In addition, units of additives not particularly described in the specification may be % by weight.

### EXAMPLE

### Preparation of Liquid electrolyte for Fast Charging

### Example 1

Ethylmethyl carbonate (EMC) and 2,2,2-trifluoroethyl acetate (TFEA) were mixed in a volume ratio of 1:9 to prepare a mixed organic solvent. To the mixed organic solvent, LiPF₆ was added to a concentration of 1.0 M, and a 1.0 M LiPF₆/MC:TFEA (1:9) liquid electrolyte was prepared. Vinylene carbonate (VC) was additionally added as an additive in an amount of 2% by weight with respect to the total weight of the liquid electrolyte.

### Example 2

An liquid electrolyte for fast charging was prepared in the same manner as in Example 1, except that EMC and TFEA were mixed in a volume ratio of 3:7.

### Example 3

An liquid electrolyte for fast charging was prepared in the same manner as in Example 1, except that EMC and TFEA were mixed in a volume ratio of 5:5.

### Example 4

An liquid electrolyte for fast charging was prepared in the same manner as in Example 1, except that EMC and TFEA were mixed in a volume ratio of 7:3.

### Example 5

An liquid electrolyte for fast charging was prepared in the same manner as in Example 1, except that EMC and TFEA were mixed in a volume ratio of 9:1.

### Example 6

An liquid electrolyte for fast charging was prepared in the same manner as in Example 2, except that 2,2,2-trifluoroethyl propionate (TFEP) was used instead of TFEA.

### Example 7

An liquid electrolyte for fast charging was prepared in the same manner as in Example 2, except that VC was included as the additive in an amount of 2% by weight with respect to the total weight of the liquid electrolyte, and fluoroethylene carbonate (FEC) was included as the additive in an amount of 2% by weight with respect to the total weight of the liquid electrolyte.

### Example 8

An liquid electrolyte for fast charging was prepared in the same manner as in Example 7, except that dimethyl carbonate (DMC) was included instead of EMC.

### Example 9

An liquid electrolyte for fast charging was prepared in the same manner as in Example 7, except that diethyl carbonate (DEC) was included instead of EMC.

### Example 10

An liquid electrolyte for fast charging was prepared in the same manner as in Example 7, except that 2,2,2-trifluoroethylmethyl carbonate (FEMC) was included instead of EMC.

### Example 11

An liquid electrolyte for fast charging was prepared in the same manner as in Example 2, except that VC was included as the additive in an amount of 2% by weight with respect to the total weight of the liquid electrolyte, and hexafluoro glutaric anhydride (HFA) was included as the additive in an amount of 0.1% by weight with respect to the total weight of the liquid electrolyte.

### Comparative Example 1

Ethylene carbonate (EC) and EMC were mixed in a volume ratio of 3:7 to prepare a mixed organic solvent, and an electrolyte was added in the same manner as in Example 1 to prepare a 1.0 M LiPF₆/EC:EMC liquid electrolyte, an existing commercially available liquid electrolyte. A vinylene carbonate (VC) additive was additionally added in an amount of 2% by weight with respect to the total weight of the liquid electrolyte.

### Comparative Example 2

An liquid electrolyte for fast charging was prepared in the same manner as in Comparative Example 1, except that VC was included as the additive in an amount of 2% by weight with respect to the total weight of the liquid electrolyte, and fluoroethylene carbonate (FEC) was included as the additive in an amount of 2% by weight with respect to the total weight of the liquid electrolyte.

### Comparative Example 3

An liquid electrolyte for fast charging was prepared in the same manner as in Example 2, except that propylene carbonate (PC) was included instead of EMC.

### Comparative Example 4

An liquid electrolyte for fast charging was prepared in the same manner as in Comparative Example 3, except that, instead of VC, FEC was included as the additive in an amount of 2% by weight with respect to the total weight of the liquid electrolyte.

### Comparative Example 5

An liquid electrolyte for fast charging was prepared in the same manner as in Comparative Example 3, except that VC was included as the additive in an amount of 2% by weight with respect to the total weight of the liquid electrolyte, and fluoroethylene carbonate (FEC) was included as the additive in an amount of 2% by weight with respect to the total weight of the liquid electrolyte.

### Comparative Example 6

An liquid electrolyte for fast charging was prepared in the same manner as in Example 7, except that FEMC was included instead of TFEA.

### Comparative Example 7

An liquid electrolyte for fast charging was prepared in the same manner as in Comparative Example 1, except that VC was included as the additive in an amount of 2% by weight with respect to the total weight of the liquid electrolyte, and hexafluoro glutaric anhydride (HFA) was included as the additive in an amount of 0.1% by weight with respect to the total weight of the liquid electrolyte.

### Comparative Example 8

An liquid electrolyte for fast charging was prepared in the same manner as in Example 1, except that EMC and TFEA were mixed in a volume ratio of 1:10.

### Comparative Example 9

An liquid electrolyte for fast charging was prepared in the same manner as in Example 1, except that EMC and TFEA were mixed in a volume ratio of 10:1.

Specific substances for the examples and the comparative examples are shown in the following Table 1.

TABLE 1

| | | | Volume Ratio | |
|---|---|---|---|---|
| | | | of First | |
| | First Solvent | Second Solvent | solvent:Second | Additive |
| | (Linear Carbonate) | (Linear Ester) | Solvent | (No/Yes) |
| Example 1 | EMC | TFEA | 1:9 | Yes (2 wt % VC) |
| Example 2 | (Same as above) | (Same as above) | 3:7 | Yes (2 wt % VC) |
| Example 3 | (Same as above) | (Same as above) | 5:5 | Yes (2 wt % VC) |
| Example 4 | (Same as above) | (Same as above) | 7:3 | Yes (2 wt % VC) |
| Example 5 | (Same as above) | (Same as above) | 9:1 | Yes (2 wt % VC) |
| Example 6 | (Same as above) | TFEP | 3:7 | Yes (2 wt % VC) |
| Example 7 | (Same as above) | TFEA | (Same as above) | Yes (2 wt % VC, |
| | | | | 2 wt % FEC) |
| Example 8 | DMC | TFEA | (Same as above) | Yes (2 wt % VC, |
| | | | | 2 wt % FEC) |
| Example 9 | DEC | (Same as above) | (Same as above) | Yes (2 wt % VC, |
| | | | | 2 wt % FEC) |
| Example 10 | FEMC | (Same as above) | (Same as above) | Yes (2 wt % VC, |
| | | | | 2 wt % FEC) |
| Example 11 | EMC | TFEA | (Same as above) | Yes (2 wt % VC, |
| | | | | 0.1 wt % HFA) |
| Comparative | EC | EMC | (Same as above) | Yes (2 wt % VC) |
| Example 1 | | | | |
| Comparative | (Same as above) | (Same as above) | (Same as above) | Yes (2 wt % VC, |
| Example 2 | | | | 2 wt % FEC) |
| Comparative | PC | TFEA | (Same as above) | Yes (2 wt % VC) |
| Example 3 | | | | |
| Comparative | (Same as above) | (Same as above) | (Same as above) | Yes (2 wt % FEC) |
| Example 4 | | | | |
| Comparative | (Same as above) | (Same as above) | (Same as above) | Yes (2 wt % VC, |
| Example 5 | | | | 2 wt % FEC) |
| Comparative | EMC | FEMC | (Same as above) | Yes (2 wt % VC, |
| Example 6 | | | | 2 wt % FEC) |
| Comparative | EC | EMC | (Same as above) | Yes (2 wt % VC, |
| Example 7 | | | | 0.1 wt % HFA) |
| Comparative | EMC | TFEA | 1:10 | Yes (2 wt % VC) |
| Example 8 | | | | |
| Comparative | (Same as above) | (Same as above) | 10:1 | Yes (2 wt % VC) |
| Example 9 | | | | |

### Experimental Example

1) Self-Extinguishing Time (SET, second/g)

Each of the liquid electrolytes prepared in Examples 1 to 11 and Comparative Examples 1 to 9 was ignited with a torch, and after removing the torch, a self-extinguishing time ((second, s), SET) per the liquid electrolyte weight (g) was measured. SET<6 may be defined as non-flammable, 6<SET<20 as flame retardant and SET>20 as flammable.

### 2) Charge-Discharge Test 1

A 2032 coin lithium ion battery (full-cell) formed with a high-loading silicon oxide (SiO) (5% by weight)-graphite composite negative electrode, a LiNi_{0.88}Co_{0.008}Mn_{0.04}O₂ positive electrode (active material per area: 18 mg/cm²), each of the liquid electrolytes prepared in Examples 1 to 5 and Comparative Examples 1 to 9, and a separator was manufactured.

A charge-discharge cycle of the lithium metal battery including the liquid electrolyte was performed 50 times with 1 C (charged in 1 hour) in a high voltage range of 2.5 V to 4.35 V to measure discharge capacity per weight (specific gravimetric capacity) and initial Coulombic efficiency under a 0.1 C chemical condition, and a capacity retention rate was calculated according to the following calculation formula.

$$Capacity retention ( \% ) = ( discharge capacity after 50 times / discharge capacity after 1 time ) \times 100$$

Specific test results are shown in the following Table 2.

TABLE 2

| | Liquid Electrolyte | | SiO-Graphite//LiNi_{0.88}Co_{0.08}Mn_{0.04}O₂ Lithium | | |
|---|---|---|---|---|---|
| | Property Evaluation | | Ion Battery Chage-Discharge Test 1 | | |
| | | Determination | Discharge | Capacity | Initial |
| | SET | of Non- | Capacity (1 C) | Retention | Coulombic |
| | (Second/g) | Flammability | (mAh/g) | (1 C) (%) | Efficiency (%) |
| Example 1 | 0 | Non-Flammable | 179 | 86 | 79 |
| Example 2 | 0 | Non-Flammable | 201 | 89 | 82 |
| Example 3 | 13 | Flame-Retardant | 199 | 88 | 82 |
| Example 4 | 57 | Flammable | 173 | 85 | 77 |
| Example 5 | 55 | Flammable | 149 | 79 | 66 |
| Example 6 | 14 | Flame-Retardant | — | — | — |
| Example 7 | 0 | Non-Flammable | — | — | — |
| Example 8 | 0 | Non-Flammable | — | — | — |
| Example 9 | 0 | Non-Flammable | — | — | — |
| Example 10 | 0 | Non-Flammable | — | — | — |
| Example 11 | 0 | Non-Flammable | — | — | — |
| Comparative | 60 | Flammable | 188 | 80 | 82 |
| Example 1 | | | | | |
| Comparative | 45 | Flammable | — | — | — |
| Example 2 | | | | | |
| Comparative | 3 | Non-Flammable | — | — | — |
| Example 3 | | | | | |
| Comparative | 0 | Non-Flammable | — | — | — |
| Example 4 | | | | | |
| Comparative | 0 | Non-Flammable | — | — | — |
| Example 5 | | | | | |
| Comparative | 0 | Non-Flammable | — | — | — |
| Example 6 | | | | | |
| Comparative | 47 | Flammable | — | — | — |
| Example 7 | | | | | |
| Comparative | 0 | Flame-Retardant | 178 | 86 | 81 |
| Example 8 | | | | | |
| Comparative | 63 | Flammable | 147 | 61 | 75 |
| Example 9 | | | | | |

As described in Table 2, the liquid electrolytes of Comparative Examples 1, 2 and 7, which are existing commercially available liquid electrolytes, had a self-extinguishing time of 60 seconds/g, 45 seconds/g and 47 seconds/g, respectively, and showed flammable properties. The liquid electrolytes of Comparative Examples 3 to 6 had a self-extinguishing time of 3 seconds/g and 0 second/g, and showed non-flammable properties. On the other hand, the liquid electrolytes of Examples 1 to 3, Examples 6 to 11 and Comparative Example 8 had, despite including 1% by volume to 50% by volume of EMC, DMC and DEC known as flammable materials, a self-extinguishing time of less than 20 seconds/g, and were identified to have non-flammable and flame retardant properties. Comparative Example 9 included EMC, a flammable material, in 100% by volume, and thereby had flammable properties.

Particularly, Examples 2 and 3 were measured to have 1 C discharge capacity of 199 mAh/g or greater, a 1 C capacity retention rate of 85% or greater and initial Coulombic efficiency of 82% or greater in the high-loading SiO-graphite composite//LiNi_{0.88}Co_{0.08}Mn_{0.04}O₂ lithium ion battery (full-cell), and exhibited excellent battery properties compared to Comparative Example 1, a commercially available liquid electrolyte, despite having non-flammable and flame-retardant properties. However, Example 1 and Comparative Example 8 with different mixing ratios between the first solvent and the second solvent had degraded battery properties compared to Examples 2 and 3, although having non-flammable properties. Comparative Example 9 had flammable properties, and had degraded battery properties as well.

### 3) Charge-Discharge Test 2

A 2032 coin lithium ion battery (full-cell) formed with a high-loading silicon oxide (SiO) (5% by weight)-graphite composite negative electrode, a LiNi_{0.88}Co_{0.08}Mn_{0.04}O₂ positive electrode (active material per area: 18 mg/cm²), each of the liquid electrolytes prepared in Examples 2 and 6 and Comparative Examples 1 and 3, and a separator was manufactured.

A charge-discharge cycle of the lithium ion battery including the liquid electrolyte was performed 100 times with 1 C (charged in 1 hour) in a high voltage range of 2.5 V to 4.35 V to measure discharge capacity per weight (specific gravimetric capacity) and initial Coulombic efficiency under a 0.1 C chemical condition, and a capacity retention rate was calculated according to the following calculation formula.

Capacity retention (%)=(discharge capacity after 100 times/discharge capacity after 1 time)×100

Specific test results are shown in the following Table 3.

TABLE 3

| | SiO-Graphite//LiNi_{0.88}Co_{0.08}Mn_{0.04}O₂ Lithium Ion Battery | | |
|---|---|---|---|
| | | Capacity | |
| | Discharge | Retention | Initial |
| | Capacity | (1 C) after | Coulombic |
| | (1 C) (mAh/g) | 100 Times (%) | Efficiency (%) |
| Example 2 | 201 | 84 | 83 |
| Example 6 | 197 | 74 | 83 |
| Comparative | 188 | 72 | 82 |
| Example 1 | | | |
| Comparative | 190 | 85 | 87 |
| Example 3 | | | |

As described in Table 3, the liquid electrolytes of Examples 2 and 6 had improved battery properties such as capacity, capacity retention rate and initial Coulombic efficiency under a condition of 1 C (charged in 1 hour) in the high-loading SiO-graphite//LiNi_{0.88}Co_{0.08}Mn_{0.04}O₂ lithium ion battery (full-cell) compared to the liquid electrolyte of Comparative Example 1, an existing commercially available liquid electrolyte. This indicates that, by using the liquid electrolyte of the present disclosure, properties and battery lifetime of the high energy density battery in which a high-capacity SiO-graphite composite negative electrode active material is used in high loading at a commercialization level are improved. In addition, the liquid electrolyte of Example 2, which is a non-flammable liquid electrolyte formed with linear carbonate and linear ester, had improved capacity properties and similar capacity retention rate and initial Coulombic efficiency compared to the liquid electrolyte of Comparative Example 3, which is a non-flammable liquid electrolyte using cyclic carbonate PC as the solvent, under a condition of 1 C (charged in 1 hour). Through this, it is seen that a battery using an liquid electrolyte formed with linear carbonate and linear ester without cyclic carbonate can be driven.

### 4) Charge-Discharge Test 3

A 730 mAh pouch lithium ion battery formed with a graphite negative electrode, a LiNi_{0.8}Co_{0.1}Mn_{0.1}O₂ positive electrode, each of the liquid electrolytes prepared in Example 2 and Comparative Examples 1 and 4, and a separator was manufactured.

A charge-discharge cycle of the pouch lithium ion battery including the liquid electrolyte was performed 200 times with 1 C (charged in 1 hour) in a high voltage range of 2.7 V to 4.3 V to measure discharge capacity and initial Coulombic efficiency under a 0.1 C chemical condition, and a capacity retention rate was calculated according to the following calculation formula.

Capacity retention (%)=(discharge capacity after 200 times/discharge capacity after 1 time)×100

### 5) Charge-Discharge Test 4

A 730 mAh pouch lithium ion battery formed with a graphite negative electrode, a LiNi_{0.8}Co_{0.1}Mn_{0.1}O₂ positive electrode, each of the liquid electrolytes prepared in Examples 7 to 10 and Comparative Example 2, 5 and 6, and a separator was manufactured.

A charge-discharge cycle of the pouch lithium ion battery including the liquid electrolyte was performed 100 times with 2 C (charged in 30 minutes) in a high voltage range of 2.7 V to 4.3 V to measure discharge capacity and initial Coulombic efficiency under a 0.1 C chemical condition, and a capacity retention rate was calculated according to the following calculation formula.

Capacity retention (%)=(discharge capacity after 100 times/discharge capacity after 1 time)×100

Specific test results are shown in the following Table 4.

TABLE 4

| | Graphite//LiNi_{0.8}Co_{0.1}Mn_{0.1}O₂ Pouch Lithium Ion Battery | | | | | |
|---|---|---|---|---|---|---|
| | | | | | Capacity | |
| | Discharge | | Initial | Discharge | Retention | Initial |
| | Capacity | Capacity | Coulombic | Capacity | (2 C) after | Coulombic |
| | (1 C) | Retention | Efficiency | (2 C) | 100 Times | Efficiency |
| | (mAh) | (1 C) (%) | (%) | (mAh) | (%) | (%) |
| Example 2 | 816 | 85 | 92 | — | — | — |
| Example 7 | — | — | — | 790 | 98 | 98 |
| Example 8 | — | — | — | 737 | 63 | 98 |
| Example 9 | — | — | — | 671 | 43 | 97 |
| Example 10 | — | — | — | 813 | 33 | 97 |
| Comparative | 796 | 69 | 86 | — | — | — |
| Example 1 | | | | | | |
| Comparative | — | — | — | 748 | 85 | 98 |
| Example 2 | | | | | | |
| Comparative | 823 | 87 | 89 | — | — | — |
| Example 4 | | | | | | |
| Comparative | — | — | — | 773 | 61 | 89 |
| Example 5 | | | | | | |
| Comparative | — | — | — | 781 | 64 | 98 |
| Example 6 | | | | | | |

The liquid electrolytes of Examples 2 and 7 had improved battery properties such as capacity or capacity retention rate and Coulombic efficiency under a condition of 1 C and 2 C in the graphite//LiNi_{0.8}Co_{0.1}Mn_{0.1}O₂ 730 mAh pouch lithium ion battery compared to the liquid electrolytes of Comparative Examples 1 and 2, which are existing commercially available liquid electrolytes. Particularly, Example 7 described in Table 3 had significantly improved battery properties under a condition of 2 C (charged in 30 minutes), and had improved battery properties such as capacity or capacity retention rate and Coulombic efficiency compared to Comparative Example 5 and 6, which are non-flammable liquid electrolytes, as well as Comparative Example 2, which is an existing commercially available liquid electrolyte. This indicates that, by using the liquid electrolyte of the present disclosure enables, fast charging of a battery is possible and battery lifetime is improved even under a condition of high charging speed. However, Examples 8 to 10 using DMC, DEC and FEMC as the first solvent had degraded battery properties compared to Example 7.

### 6) Charge-Discharge Test 5

A 730 mAh pouch lithium ion battery formed with a graphite negative electrode, a LiNi_{0.8}Co_{0.1}Mn_{0.1}O₂ positive electrode, each of the liquid electrolytes prepared in Example 11 and Comparative Example 7, and a separator was manufactured.

A charge-discharge cycle of the pouch lithium ion battery including the liquid electrolyte was performed 100 times by charging with 3 C (charged in 20 minutes) and discharging with 1 C (discharged in 1 hour) in a high voltage range of 2.7 V to 4.3 V to measure discharge capacity and initial Coulombic efficiency under a 0.1 C chemical condition, and a capacity retention rate was calculated according to the following calculation formula.

Capacity retention (%)=(discharge capacity after 100 times/discharge capacity after 1 time)×100

Specific test results are shown in the following Table 5.

TABLE 5

| | Graphite//LiNi_{0.8}Co_{0.1}Mn_{0.1}O₂ Pouch Lithium Ion Battery | | |
|---|---|---|---|
| | Discharge | Capacity | Initial |
| | Capacity | Retention | Coulombic |
| | (3 C) (mAh) | (3 C) (%) | Efficiency (%) |
| Example 11 | 798 | 98 | 99 |
| Comparative | 762 | 83 | 98 |
| Example 7 | | | |

The liquid electrolyte of Example 11 had improved battery properties such as capacity or capacity retention rate and Coulombic efficiency under a condition of 3 C charge-1 C discharge in the graphite//LiNi_{0.8}Co_{0.1}Mn_{0.1}O₂ 730 mAh pouch lithium ion battery compared to the liquid electrolyte of Comparative Example 7, an existing commercially available liquid electrolyte. This indicates that, by using the liquid electrolyte of the present disclosure, fast charging of a battery is possible and battery lifetime is improved compared to a commercially available liquid electrolyte even under a condition of high charging speed.

Hereinbefore, preferred embodiments of the present disclosure have been described in detail, however, the scope of a right of the present disclosure is not limited thereto, and various modified and improved forms made by those skilled in the art using the basic concept of the present disclosure defined in the claims also fall within the scope of a right of the present disclosure.

### INDUSTRIAL APPLICABILITY

The present disclosure relates to an liquid electrolyte for a fast charging lithium secondary battery, a lithium secondary battery including the same, and a method for manufacturing a lithium secondary battery.

1. An liquid electrolyte for fast charging of a lithium secondary battery, the liquid electrolyte comprising:
a lithium salt;
a first solvent including a compound represented by the following Chemical Formula 1; and
a second solvent including a compound represented by the following Chemical Formula 2: 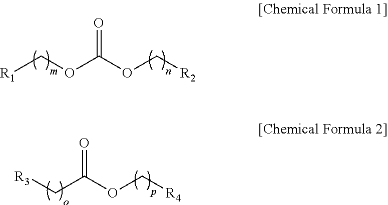
wherein,
n, m, o and p are the same as or different from each other, and each independently an integer of 0 to 5; and
R₁ to R₄ are the same as or different from each other, and each independently selected from the group consisting of hydrogen, a substituted or unsubstituted alkyl group having 1 to 10 carbon atoms, a substituted or unsubstituted alkenyl group having 2 to 10 carbon atoms and a substituted or unsubstituted alkynyl group having 2 to 10 carbon atoms.

2. The liquid electrolyte of claim 1, wherein the lithium salt is selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂, LiN(FSO₂)₂, LiN(CₓF₂ₓ₊₁SO₂)(C_{y}F_{2y+1}SO₂) (herein, x and y are 0 or natural number), LiCl, LiI, LiSCN, LiB(C₂O₄)₂, LiF₂BC₂O₄, LiPF₄(C₂O₄), LiPF₂(C₂O₄)₂, LiPO₂F₂, LiP(C₂O₄)₃ and mixtures thereof.

3. The liquid electrolyte of claim 1, comprising the first solvent and the second solvent in a volume ratio of 99:1 to 1:99.

4. The liquid electrolyte of claim 1, comprising the lithium salt in a concentration of 0.1 M to 60 M.

5. The liquid electrolyte of claim 1, wherein the liquid electrolyte composition further includes an additive selected from the group consisting of vinylene carbonate (VC), vinylene ethylene carbonate (VEC), propane sultone (PS), fluoroethylene carbonate (FEC), ethylene sulfate (ES), lithium fluorophosphate (LiPO₂F₂), lithium oxalyl difluoroborate (LiODFB), hexafluoro glutaric anhydride (HFA), lithium bis(oxalato)borate (LiBOB) and mixtures thereof.

6. The liquid electrolyte of claim 5, wherein the additive is included in an amount of 0.1% by weight to 13% by weight in a total weight of the liquid electrolyte.

7. A lithium secondary battery comprising:
a positive electrode including a positive electrode active material;
the liquid electrolyte of claim 1;
a negative electrode; and
a separator.

8. The lithium secondary battery of claim 7, wherein the positive electrode includes a nickel-rich NCM-based material as the positive electrode active material.

9. The lithium secondary battery of claim 7, wherein the separator is polyethylene, polypropylene, polyvinylidene fluoride or a multilayer film of two or more layers thereof, or coated with ceramic.

10. The lithium secondary battery of claim 7, which is a lithium ion secondary battery or a lithium metal secondary battery.

11. A method for manufacturing a lithium secondary battery, the method comprising:
a) preparing a positive electrode including a positive electrode active material, a polymer binder and a conductor on a current collector;
b) preparing an electrode assembly in which the positive electrode, a separator and a negative electrode are sequentially interposed; and
c) inserting the electrode assembly into a battery case, and injecting a lithium salt and the liquid electrolyte of claim 1 thereinto.
